(19) United States
(12) Patent Application Publication
(10) Pub. No.: US 2014/0281678 A1
(43) Pub. Date: Sep. 18, 2014

(54) MEMORY CONTROLLER AND MEMORY SYSTEM

(71) Applicant: KABUSHIKI KAISHA TOSHIBA, Minato-ku (JP)

(72) Inventors: Takuya HAGA, Yokohama-shi (JP); Tarou IWASHIRO, Yokohama-shi (JP)

(73) Assignee: KABUSHIKI KAISHA TOSHIBA, Minato-ku (JP)

(21) Appl. No.: 14/017,614

(22) Filed: Sep. 4, 2013

Related U.S. Application Data
(60) Provisional application No. 61/784,491, filed on Mar. 14, 2013.

(51) Int. Cl. G06F 11/07

(52) U.S. Cl. CPC G06F 11/0727
USPC 714/6.1

(57) ABSTRACT

According to one embodiment, a memory controller includes a plurality of operation units respectively provided for a plurality of stages and each performing an error correcting operation for data supplied from an external device or data read from a nonvolatile semiconductor memory.

### CROSS-REFERENCE TO RELATED APPLICATIONS

This application claims the benefit of U.S. Provisional Application No. 61/784,491, filed Mar. 14, 2013, the entire contents of which are incorporated herein by reference.

### FIELD

Embodiments described herein relate generally to a memory system.

### BACKGROUND

The technique related to an error correcting code of digital data is developed to record data in a semiconductor memory device with high density. The system for error correcting codes is roughly divided into an algebraic error correcting system and an error correcting system by repetitive calculations based on probability.

### BRIEF DESCRIPTION OF THE DRAWINGS

FIG. 1 is a block diagram schematically showing the basic configuration of a memory system according to a first embodiment.

FIG. 2 is a block diagram schematically showing the basic configuration of a NAND flash memory according to the first embodiment.

FIG. 3 is a block diagram schematically showing the basic configuration of a memory cell array according to the first embodiment.

FIG. 4 shows a circuit example of one of plural memory blocks shown in FIG. 3.

FIG. 5 is a block diagram schematically showing the basic configuration of an ECC circuit according to the first embodiment.

FIG. 6 shows an example of an error number history table according to the first embodiment.

FIG. 7 shows an example of a parameter table according to the first embodiment.

FIG. 8 is a diagram showing a concrete operation example 1 of the ECC circuit according to the first embodiment.

FIG. 9 is a diagram showing a concrete operation example 2 of the ECC circuit according to the first embodiment.

FIG. 10 is a block diagram schematically showing the basic configuration of a memory system according to a second embodiment.

FIG. 11 is a block diagram schematically showing the basic configuration of an ECC circuit according to the second embodiment.

FIG. 12 shows an example of a status of cycle number table according to the second embodiment.

FIG. 13 shows an example of a target cycle number table according to the second embodiment.

FIG. 14 is a block diagram schematically showing the basic configuration of an ECC circuit according to a third embodiment.

FIG. 15 shows an example of a parameter table according to the third embodiment.

FIG. 16 is a block diagram schematically showing the basic configuration of an ECC circuit according to a fourth embodiment.

FIG. 17 shows an example of a parameter table according to the fourth embodiment.

### DETAILED DESCRIPTION

In general, according to one embodiment, a memory controller includes a plurality of operation units respectively provided for a plurality of stages and each performing an error correcting operation for data supplied from an external device or data read from a nonvolatile semiconductor memory, a management unit provided for the plural operation units and which manages preset information related to data input to a corresponding one of the operating units, and a parameter control unit which outputs a parameter used for controlling the operation of the operation unit based on the preset information when receiving the preset information from the management unit.

Next, one embodiment is explained in detail with reference to the drawings. In the following explanation, the same symbols are attached to constituents having substantially the same functions and configurations and the repetitive explanation is made only when required. Further, the following embodiments are provided only as examples of devices and methods for embodying the technical idea of the embodiments and the technical idea of the embodiments does not specifically limit the materials, shapes, configurations, arrangements and the like of configuration parts to the described below. The technical idea of the embodiments can be variously modified in the scope of the claims.

### First Embodiment

<Configuration of Memory System>

The basic configuration of a memory system 100 according to the present embodiment is schematically explained with reference to FIG. 1.

As shown in FIG. 1, the memory system 100 includes a memory controller 100a and flash memory 109.

The memory controller 100a includes a CPU (central processing unit) 103, RAM 105 and ROM 106. The CPU 103 controls the flash memory 109 based on data (instruction or control program) stored in the RAM 105 or ROM 106.

The memory controller 100a includes a host interface (that is hereinafter simply referred to as a host I/F) 101, memory buffer 102, CPU 103, bus 104, RAM 105, ROM 106, ECC (error correcting code) circuit 107 and flash interface (that is hereinafter simply referred to as a flash I/F) 108.

The host interface 101 is connected to a host device (external device) 200 such as a personal computer and is further connected to the bus 104. Data is transferred between the host device 200 and the memory system 100 via the host interface 101.

The memory buffer 102 is connected to the host interface 101 and is further connected to the bus 104. The memory buffer 102 receives data transmitted from the host device 200 to the memory system 100 via the host interface 101 and temporarily holds the same. Further, the memory buffer 102 temporarily holds data transmitted from the memory system 100 to the host device 200 via the host interface 101.

The CPU 103 controls the operation of the whole portion of the memory system 100. For example, the CPU 103 performs a preset process with respect to the flash memory 109 according to a command received from the host device 200 according to a control program.

The RAM 105 is a volatile memory, is used as a working area of the CPU 103 and temporarily stores variables and the like required for the operation of the CPU 103. Further, the RAM 105 may hold an instruction code for accessing the flash memory 109 and various table information used in the ECC circuit 107 that will be described later.

The ROM 106 is a nonvolatile memory and stores a control program and the like controlled by the CPU 103.

The ECC circuit 107 is connected to the memory buffer 102, RAM 105 and ROM 106. The ECC circuit 107 receives write data from the host device 200 via the memory buffer 102, adds an error correcting code to the write data and supplies the write data having the error correcting code added thereto to the memory buffer 102 or flash interface 108, for example. Further, the ECC circuit 107 receives data supplied from the flash memory 109 via the flash interface 108, subjects the data to an error correction by use of an error correcting code and supplies the error-corrected data to the memory buffer 102, RAM 105, ROM 106 or the like, for example.

The ECC circuit 107 includes an operation unit 110, stage management unit 120, operation parameter control unit 130 and operation control unit 140.

The operation unit 110 performs an error correcting operation based on a pipeline process for input data before correction input to the ECC circuit 107.

For example, the stage management unit 120 is a config. register and manages attribute information of input data before correction input to the ECC circuit 107.

For example, the operation parameter control unit 130 includes a table and calculates an optimum operation parameter of the operation unit 110 based on information received from the operation unit 110 or stage management unit 120. The table held in the operation parameter control unit 130 is read from the flash memory 109 at the start time of the memory system 100, for example.

The operation control unit 140 generates a control signal to the operation unit 110 based on a parameter value calculated in the operation parameter control unit 130. The operation unit 110 performs an operation in the operation mode corresponding to the control signal.

The flash interface 108 is connected to the ECC circuit 107 and bus 104.

The flash memory 109 includes a page buffer and memory that are not shown here. The page buffer reads data from the memory based on a command supplied from the memory controller 100a and temporarily holds the data. Then, for example, the data is supplied to the memory controller 100a via the flash interface 108. The memory is a memory cell array that includes a plurality of bit lines, a plurality of word lines and a common source line and in which, for example, electrically data rewritable memory cells formed of EPROM cells are arranged in a matrix form.

In the present embodiment, the NAND flash memory is used as the nonvolatile flash memory 109, but this embodiment is not limited to this case.

<Whole Configuration of NAND Flash Memory>

Next, the configuration of the NAND flash memory 109 according to the first embodiment is schematically explained with reference to FIG. 2. FIG. 2 is a block diagram schematically showing the basic configuration of the NAND flash memory 109 according to the first embodiment.

As shown in FIG. 2, the NAND flash memory 109 includes a memory cell array 11, bit line control circuit 12, column decoder 13, data input/output buffer 14, data input/output terminal 15, row decoder 16, control circuit 17, control signal input terminal 18 and source line control circuit 19.

The memory cell array 11 includes a plurality of bit lines BL, a plurality of word lines WL and source line SRC. The memory cell array 11 includes a plurality of blocks BLK each having electrically rewritable memory cell transistors (that are hereinafter simply referred to as memory cells) MC arranged in a matrix form. For example, memory cell transistor MC has a stacked gate including a control gate electrode and charge storage layer (for example, floating gate electrode) and stores multi-valued data according to a variation in the threshold value of a transistor determined by the amount of charges injected into the floating gate electrode. Further, memory cell transistor MC may have a MONOS (Metal-Oxide-Nitride-Oxide-Silicon) structure that traps electrons in a nitride film.

The bit line control circuit 12 includes a sense amplifier (not shown) that senses and amplifies a voltage of bit line BL in the memory cell array 11, a data storage circuit (not shown) that latches data to be written and the like. The bit line control circuit 12 reads data of memory cell transistor MC in the memory cell array 11 via bit line BL, detects the state of memory cell transistor MC in the memory cell array 11 via bit line BL and applies a write control voltage to memory cell transistor MC via bit line BL to write data in memory cell transistor MC.

The column decoder 13 selects one of data storage circuits in the bit line control circuit 12 and outputs data of memory cell transistor MC that is read to the data storage circuit from the data input/output terminal 15 to the exterior (controller 100a) via the data input/output buffer 14.

The data input/output buffer 14 receives data from the data input/output terminal 15 and the data is stored in the data storage circuit selected by the column decoder 13. Further, the data input/output buffer 14 outputs data to the exterior via the data input/output terminal 15.

The data input/output terminal 15 receives various commands and addresses for writing, reading, erasing, status reading and the like in addition to write data.

The row decoder 16 selects one of blocks BLK at the time of the data read operation, write operation or erase operation and sets the remaining blocks BLK in an unselected state. That is, the row decoder 16 applies voltages required for the read operation, write operation or erase operation to word lines WL and select gate lines VSGS, VSGD of the memory cell array 11.

The source line control circuit 19 controls the voltage of source line SRC.

The control circuit 17 controls the memory cell array 11, bit line control circuit 12, column decoder 13, data input/output buffer 14, row decoder 16 and source line control circuit 19. It is supposed that the control circuit 17 includes a booster circuit (not shown) that boosts the power supply voltage. The control circuit 17 boosts the power supply voltage as required by use of the booster circuit and applies the voltage to the bit line control circuit 12, column decoder 13, data input/output buffer 14, row decoder 16 and source line control circuit 19.

The control circuit 17 performs a control operation according to a control signal (command latch enable signal CLE, address latch enable signal ALE, ready/busy signal RY/BY or the like) input from the exterior via the control signal input terminal 18 and a command input from the data input/output terminal 15 via the data input/output buffer 14. That is, the control circuit 17 generates desired voltages at the data programming, verifying, reading or erasing time according to the control signal and command and applies the voltage to the respective portions of the memory cell array 11.

<Outline of Memory Cell Array>

FIG. 3 is a block diagram schematically showing the basic configuration of the memory cell array 11 according to the present embodiment. Further, FIG. 4 shows a circuit example of one of the plural memory blocks shown in FIG. 3.

The memory cell array 11 includes a plurality of memory blocks BLOCK1 to BLOCKm (m is an integral number equal to or larger than 1). Plural memory blocks BLOCK1 to BLOCKm are arranged side by side in a direction of bit line BL (column direction).

As shown in FIG. 4, each memory block includes a plurality of NAND cells (that are also referred to as cell units, NAND strings or the like) arranged in a direction of word line WL (row direction).

Each NAND cell includes a plurality of series-connected memory cell transistors (that are also simply referred to as memory cells) MT, select gate transistor ST1 connected to the drain of one of memory cell transistors MT that is arranged on one end and select gate transistor ST2 connected to the source of one of memory cell transistors MT that is arranged on the other end.

Each memory cell transistor MT includes a charge storage layer formed above a semiconductor substrate with a gate insulating film disposed therebetween, a gate insulating film formed on the charge storage layer and a control gate formed on the gate insulating film. The number of memory cell transistors MT is not limited to 8, but may be set to 16, 32, 64, 128, 256 or the like and the number is not limited. Adjacent ones of memory cell transistors MT commonly have the source or drain. The transistors are arranged with the current paths thereof serially connected between select gate transistors ST1 and ST2. The drain region on one end side of series-connected memory cell transistors MT is connected to the source region of select gate transistor ST1 and the source region on the other end side thereof is connected to the drain region of select gate transistor ST2.

Bit lines BL0 to BLq−1 (q is an integral number equal to or larger than 1) are respectively connected to the drains of select gate transistors ST1. Source line SL is connected to the sources of select gate transistors ST2. Bit lines BL0 to BLq−1 are called bit lines BL when they are not distinguished. Further, both of select gate transistors ST1, ST2 are not always necessary and it is sufficient to provide only one of them if the NAND cell can be selected.

Word lines WL0 to WLn−1 (n is an integral number equal to or larger than 1) are formed to extend in a WL direction and are each commonly connected to memory cells arranged in the WL direction. For simplifying the explanation, word lines WL0 to WL7 are sometimes simply called word lines WL in the following description when they are not distinguished.

Select gate lines SGD, SGS are respectively commonly connected to the gate electrodes of select transistors ST1, ST2 of the memory cells.

Data is simultaneously written in plural memory cell transistors MT connected to the same word line WL and this unit is called a page. Further, data of the plural NAND cells arranged on the same row are simultaneously erased and this unit is called a memory block.

<Outline of ECC Circuit According to First Embodiment>

Next, the basic configuration of the ECC circuit 107 according to the first embodiment is explained with reference to FIG. 5 to FIG. 7. FIG. 5 is a block diagram showing the basic configuration of the ECC circuit 107 according to the first embodiment. FIG. 6 shows an example of an error number history table according to the first embodiment. FIG. 7 shows an example of a parameter table according to the first embodiment.

As shown in FIG. 5, the ECC circuit 107 divides to-be-corrected input data into a plurality of stages 1 to N (N is an integral number equal to or larger than 1) and then processes the data.

As shown in FIG. 5, the operation unit 110 includes a stage operation unit 111-1 of a stage 1 to a stage operation unit 111-N of a stage N, for example. If the stage operation unit 111-1 of the stage 1 to the stage operation unit 111-N of the stage N are not distinguished, they are simply referred to as stage operation units 111. The stage operation unit 111 of each stage performs a pipeline process. That is, data before correction input to the operation unit 110 is subjected to a process of a pipeline stage number and is then output as data after correction. The stage operation unit 111 specifies the location and the number of to-be-corrected errors before correcting an error of input data.

The stage management unit 120 includes stages corresponding in number to the stage operation units 111, that is, a stage management unit 121-1 of the stage 1 to a stage management unit 121-N of the stage N. If the stage management unit 121-1 of the stage 1 to the stage management unit 121-N of the stage N are not distinguished, they are simply referred to as stage management units 121.

The stage management unit 121 holds attribute information corresponding to input data that is subjected to the operating process in the stage operation unit 111 of the same stage. Then, the stage management unit 121 supplies attribute information of input data added to input data to the stage management unit 121 of the next stage and table control unit 132 in synchronism with the process of the stage operation unit 111.

The stage management unit 121 acquires an error bit number of input data specified by the stage operation unit 111 and supplies corresponding attribute information and error bit number to an error number history table 131.

In FIG. 5, the error bit number is output by the stage management unit 121-N of the final stage N, but when the stage operation unit 111 of an intermediate stage instead of the final stage N specifies the error bit number of input data, the stage management unit 121 corresponding to the above stage may output corresponding attribute information and error bit number to the error number history table 131.

Further, instead of the stage management unit 121, the stage operation unit 111 that specifies the error bit number of input data may supply the error bit number to the error number history table 131 and the stage management unit 121 may supply corresponding attribute information to the error number history table 131.

As attribute information, various information, for example, block addresses, page addresses of the flash memory, chip numbers, memory identification IDs (when plural flash memories are mounted on one memory chip) when the memory system 100 includes a plurality of flash memory chips can be considered. In addition to the above information, as attribute information, for example, page information indicating Lower/Upper when the flash memory is a multi-valued memory cell may be used, mode information when data of the memory is read while the threshold voltage is being changed may be used as attribute information or information indicating the threshold voltage with which memory data can be finally read may be used.

The operation control unit 140 includes stages corresponding in number to the stage operation units 111, that is, a stage operation control unit 141-1 of the stage 1 to a stage operation control unit 141-N of the stage N, for example. If the stage operation control unit 141-1 of the stage 1 to the stage operation control unit 141-N of the stage N are not distinguished, they are simply referred to as stage operation control units 141.

The stage operation control unit 141 supplies a control signal to the stage operation unit 111 of a corresponding stage based on a parameter supplied for each stage from the operation parameter control unit 130.

The operation parameter control unit 130 includes an error number history table 131, table control unit 132 and parameter table 133.

As shown in FIG. 6, the error number history table 131 is a table that stores error bit numbers Num1 to NumS for attribute information Attr1 to AttrS of input data. An error bit number related to attribute information of the error number history table 131 is updated each time the operation unit 110 corrects an error of input data.

For example, when the page address of the flash memory is used as attribute information, page addresses are divided into S groups and information indicating one of the S groups to which the page address used for reading data belongs is used as attribute information. The S groups correspond to S attribute information Attr1 to AttrS. By determining one of the S groups to which the page address used for reading data belongs, attribute information corresponding to the data is obtained from attribute information Attr1 to AttrS.

As the error bit number stored in the error number history table 131, a value obtained by averaging the number of several past accesses of corresponding attribute information, a value of one access at the preceding access time or the like may be considered. When the number of several past accesses is averaged, a storage area such as a buffer used for holding the average value is separately required and the averaged value is stored in the present table.

If an error bit number is not set for preset attribute information, 0 is set as the error bit number.

Further, as the error number history table 131, tables for respective types of attribute information may be formed.

As shown in FIG. 7, the parameter table 133 is a table that stores an optimum parameter of each stage for an error bit number. With the table of parameters for the respective error bit numbers, a parameter value is selected when an error bit number is input. The table may be previously set or freely set by the user.

P_{xy} shown in FIG. 7 indicates a parameter of each stage, X indicates a stage number and Y indicates an error bit number. That is, P_{xy} indicates a parameter when the stage number is X and the error bit number is Y. M indicates the maximum value of the error bit number that may occur in input data.

The parameter is used for controlling the processing speed and power consumption of the stage operation unit 111 and, for example, the parameter may be a value for determining the degree of the parallel relationship of the processes in the stage operation unit 111 or determining an operation clock frequency in the stage operation unit 111.

For example, if the degree of the parallel relationship of the processes in the stage operation unit 111 is increased, the error correction processing speed becomes higher but the power consumption of the memory system 100 increases. On the other hand, if the degree of the parallel relationship of the processes in the stage operation unit 111 is decreased, the error correction processing speed decreases but the power consumption of the memory system 100 decreases.

Further, for example, if the operation clock frequency in the stage operation unit 111 is raised, the error correction processing speed becomes higher but the power consumption of the memory system 100 increases. If the operation clock frequency in the stage operation unit 111 is lowered, the error correction processing speed decreases but the power consumption of the memory system 100 decreases.

The user can select a preset mode of the memory system 100 via the CPU 103. As the mode, for example, a “throughput preference mode” in which the power consumption is high but the operation speed of the memory system 100 is high, a “power-consumption preference mode” in which the operation speed of the memory system 100 is low but the power consumption is suppressed and the like are provided. In the following embodiments, a case wherein the two modes of the “throughput preference mode” and “power-consumption preference mode” are given as an example is explained for simplicity, but the embodiments are not limited to this case and the user can adequately select a mode other than the above two modes.

In the operation parameter control unit 130 according to this embodiment, if the “throughput preference mode” or “power-consumption preference mode” is selected by the user, an optimum parameter can be selected. As a concrete method for selecting an optimum parameter, (i) a method for selecting an optimum parameter corresponding to a selected mode from plural tables previously set in the parameter table 133, (ii) a method for reading an optimum parameter corresponding to a selected mode from the RAM 105 and overwriting the table in the parameter table 133, (iii) a method for subjecting a table previously set in the parameter table 133 to an operation according to a selected mode and the like are provided. As a concrete example of (iii), a preset number is added or a preset number is multiplied in the parameter table 133 when the user switches the modes.

As the tables held in the parameter table 133, tables may be prepared in the flash memory 109 for the respective types of attribute information or the user may freely form tables.

When receiving input data or attribute information supplied from each stage management unit 121, the table control unit 132 selects an error bit number corresponding to attribute information. Then, the table control unit 132 supplies the acquired error bit number to the parameter table 133 to select a parameter corresponding to the error bit number and stage number. Further, the unit supplies the acquired parameter to the corresponding stage operation control unit 141. As a result, the operation of correcting an error in input data can be performed in an optimum condition.

<Basic Operation of ECC Circuit According to First Embodiment>

Next, by referring to FIG. 5 again, the basic data error correction operation using the ECC circuit 107 according to this embodiment is explained.

First, data (input data) to be error-corrected is input to the stage operation unit 111-1 of the stage 1. At this time, the stage management unit 121-1 of the stage 1 acquires attribute information of the input data.

Next, the table control unit 132 acquires attribute information of the input data and refers to the error number history table 131 to acquire a corresponding error bit number. Further, the table control unit 132 acquires a parameter value from the parameter table 133 by use of the acquired error bit number. Then, the table control unit 132 supplies the acquired parameter to the stage operation control unit 141-1 of the stage 1.

The stage operation control unit 141-1 of the stage 1 supplies a control signal based on the acquired parameter to the stage operation unit 111-1 of the stage 1. When receiving the control signal corresponding to the input data, the stage operation unit 111-1 of the stage 1 starts the error correction process for the input data based on the control signal.

If the operation in the stage 1 is finished, the stage operation unit 111-1 of the stage 1 supplies input data to the stage operation unit 111-2 of the stage 2 that is a next stage of the stage 1. At this time, the stage management unit 121-1 of the stage 1 supplies attribute information of the input data to the stage management unit 121-2 of the stage 2 and table control unit 132.

Then, the table control unit 132 acquires attribute information of input data processed in the stage 2 and refers to the error number history table 131 to acquire a corresponding error bit number. Next, the table control unit 132 acquires a parameter value from the parameter table 133 by use of the acquired error bit number. Then, the table control unit 132 supplies the acquired parameter to the stage operation control unit 141-2 of the stage 2.

The stage operation control unit 141-2 of the stage 2 supplies a control signal based on the acquired parameter to the stage operation unit 111-2 of the stage 2.

When receiving the control signal corresponding to the input data, the stage operation unit 111-2 of the stage 2 starts the error correction process for the input data based on the control signal. The same process is repeatedly performed until the error correction process for the input data is completed.

For example, if an error bit number and error location of input data are derived in the stage operation unit 111-N of the final stage N, the stage operation unit 111-N inverts a value of an error portion of input data and performs an error correction process. Then, the stage management unit 121-N supplies the derived error bit number and attribute information of the input data to the error number history table 131. As a result, the error number history table 131 updates the error bit number related to the attribute information.

For example, input data including attribute information in which the error bit number of the error number history table 131 is updated is subjected to the error correction process in the stage operation unit 111 of a preset stage in some cases. In this case, for example, the table control unit 132 may grasp attribute information of the input data subjected to the correction process in each stage operation unit 111 and supply a corresponding parameter to a stage in which the operation process of input data including attribute information having the error bit number updated is performed. As a result, the condition can be changed to an optimum condition even during the error correction process.

<Operation Example 1 of ECC Circuit According to First Embodiment>

Next, a concrete operation example 1 of the ECC circuit 107 according to this embodiment is explained with reference to FIG. 8. In the operation example 1, the stage number is set to 3 for simplifying the understanding of the operation of the ECC circuit 107. Further, in the operation example 1, it is supposed that each data (data A, B, C, D) to be error-corrected has the same attribute information for simplifying the understanding of switching the operations of the stage operation unit 111 at the updating time of the error number history table 131.

As shown in FIG. 8, when data A is input to the stage operation unit 111-1 of the stage 1 at time t0, the table control unit 132 reads error bit number a set for attribute information of data A from the error number history table 131. Then, the table control unit 132 selects parameter P_{1α} of the stage 1 based on error bit number a and a stage number in which data A is processed and supplies the same to the stage operation control unit 141-1 of the stage 1. As a result, data A is subjected to an error correction process based on parameter P_{1α}.

If the stage operation unit 111-1 of the stage 1 finishes the error correction process for data A at time t1, data A is supplied to the stage operation unit 111-2 of the stage 2. Then, the table control unit 132 reads error bit number α(A) set for attribute information of data A from the error number history table 131 of state α. In this case, if the error bit number is expressed by X(Y), the error bit number indicates an error bit number derived from attribute information of data Y by referring to the error number history table 131 of state X. The table control unit 132 selects parameter P_{2α(A)} of the stage 2 based on error bit number α(A) and a stage number in which data A is processed and supplies the same to the stage operation control unit 141-2 of the stage 2. As a result, data A is subjected to an error correction process based on parameter P_{2α(A)}.

At time t1, data B is input to the stage operation unit 111-1 of the stage 1 since the stage operation unit 111-1 of the stage 1 has finished the process for data A. Then, as described before, the table control unit 132 reads error bit number α(B) set for attribute information of data B from the error number history table 131. Further, the table control unit 132 selects parameter P_{1α(B)} of the stage 1 based on error bit number a and a stage number in which data B is processed and supplies the same to the stage operation control unit 141-1 of the stage 1. As a result, data B is subjected to an error correction process based on parameter P_{1α(B)}.

At time t2, data C is input to the stage operation unit 111-1 of the stage 1 since the stage operation unit 111-1 of the stage 1 has finished the process for data B. Then, the table control unit 132 reads error bit number α(C) set for attribute information of data C from the error number history table 131. Further, the table control unit 132 selects parameter P_{1α(C)} of the stage 1 based on error bit number α(C) and a stage number in which data C is processed and supplies the same to the stage operation control unit 141-1 of the stage 1. As a result, data C is subjected to an error correction process based on parameter P_{1α(C)}.

At time t3, if the stage operation unit 111-2 of the stage 2 finishes the error correction process for data A, data A is supplied to the stage operation unit 111-3 of the stage 3. Then, the table control unit 132 reads error bit number α(A) set for attribute information of data A from the error number history table 131. Then, the table control unit 132 selects parameter P_{3α(A)} of the stage 3 based on error bit number α(A) and a stage number in which data A is processed and supplies the same to the stage operation control unit 141-3 of the stage 3. As a result, data A is subjected to an error correction process based on parameter P_{3α(A)}.

At time t3, data B is input to the stage operation unit 111-2 of the stage 2 since the stage operation unit 111-2 of the stage 2 has finished the process for data A. Then, as described before, the table control unit 132 reads error bit number α(B) set for attribute information of data B from the error number history table 131. Further, the table control unit 132 selects parameter P_{2α(B)} of the stage 2 based on error bit number α(B) and a stage number in which data B is processed and supplies the same to the stage operation control unit 141-2 of the stage 2. As a result, data B is subjected to an error correction process based on parameter P_{2α(B)}.

At time t4, if the error correction process for data A is completed in the stage operation unit 111-3 of the stage 3, an error bit number of data A is derived at this time and the error bit number of data A and attribute information of data A are supplied to the error number history table 131. As a result, the error bit number corresponding to the attribute information of data A is updated and the error number history table 131 is shifted from state a to state p. Likewise, if the error bit number is updated, the state of the error number history table is changed to a different state.

At time t5, data D is input to the stage operation unit 111-1 of the stage 1 since the stage operation unit 111-1 of the stage 1 has finished the process for data C. Then, the table control unit 132 reads error bit number β(D) set for attribute information of data D from the error number history table 131. In this case, if data A and data D have the same attribute information, an error bit number updated at time t4 is read as an error bit number corresponding to attribute information of data D. Further, the table control unit 132 selects parameter P_{1β(D)} of the stage 1 based on error bit number β(D) and a stage number in which data D is processed and supplies the same to the stage operation control unit 141-1 of the stage 1. As a result, data D is subjected to an error correction process based on parameter P_{1β(D)}.

At time t6, if the stage operation unit 111-2 of the stage 2 finishes the error correction process for data B, data B is supplied to the stage operation unit 111-3 of the stage 3. Then, the table control unit 132 reads error bit number β(B) set for attribute information of data B from the error number history table 131. Further, the table control unit 132 selects parameter P_{3β(B)} of the stage 3 based on error bit number β(B) and a stage number in which data B is processed and supplies the same to the stage operation control unit 141-3 of the stage 3. As a result, data B is subjected to an error correction process based on parameter P_{3β(B)}.

At time t6, data C is input to the stage operation unit 111-2 of the stage 2 since the stage operation unit 111-2 of the stage 2 has finished the process for data B. Then, as described before, the table control unit 132 reads error bit number β(C) set for attribute information of data C from the error number history table 131. Further, the table control unit 132 selects parameter P_{2β(C)} of the stage 2 based on error bit number β(C) and a stage number in which data C is processed and supplies the same to the stage operation control unit 141-2 of the stage 2. As a result, data C is subjected to an error correction process based on parameter P_{2β(C)}.

At time t7, if the error correction process for data B is completed in the stage operation unit 111-3 of the stage 3, an error bit number of data B is derived and the error bit number of data B and attribution information of data B are supplied to the error number history table 131. As a result, the error bit number corresponding to the attribute information of data B is updated and the error number history table 131 is shifted from state β to state γ.

At time t8, if the stage operation unit 111-2 of the stage 2 finishes the error correction process for data C, data C is supplied to the stage operation unit 111-3 of the stage 3. Then, the table control unit 132 reads error bit number γ(C) set for attribute information of data C from the error number history table 131. Further, the table control unit 132 selects parameter P_{3γ(C)} of the stage 3 based on error bit number γ(C) and a stage number in which data C is processed and supplies the same to the stage operation control unit 141-3 of the stage 3. As a result, data C is subjected to an error correction process based on parameter P_{3γ(C)}.

At time t8, data D is input to the stage operation unit 111-2 of the stage 2 since the stage operation unit 111-2 of the stage 2 has finished the process for data C. Then, as described before, the table control unit 132 reads error bit number γ(D) set for attribute information of data D from the error number history table 131. Further, the table control unit 132 selects parameter P_{2γ(D)} of the stage 2 based on error bit number γ(D) and a stage number in which data D is processed and supplies the same to the stage operation control unit 141-2 of the stage 2. As a result, data D is subjected to an error correction process based on parameter P_{2γ(D)}.

At time t9, if the error correction process for data C is completed in the stage operation unit 111-3 of the stage 3, an error bit number of data C is derived and the error bit number of data C and attribution information of data C are supplied to the error number history table 131. As a result, the error bit number corresponding to the attribute information of data C is updated and the error number history table 131 is shifted from state γ to state Δ.

At time t10, if the stage operation unit 111-2 of the stage 2 finishes the error correction process for data D, data D is supplied to the stage operation unit 111-3 of the stage 3. Then, the table control unit 132 reads error bit number Δ(D) set for attribute information of data D from the error number history table 131. Further, the table control unit 132 selects parameter P_{3Δ(D)} of the stage 3 based on error bit number Δ(D) and a stage number in which data D is processed and supplies the same to the stage operation control unit 141-3 of the stage 3. As a result, data D is subjected to an error correction process based on parameter P_{3Δ(D)}.

<Operation Example 2 of ECC Circuit According to First Embodiment>

Next, a concrete operation example 2 of the ECC circuit 107 according to this embodiment is explained with reference to FIG. 9. Like the operation example 1, in the operation example 2, it is supposed that the stage number is set to 3 and each data (data A, B, C, D) to be error-corrected has the same attribute information for simplifying the understanding of the operation of the ECC circuit 107. Further, since the operations of the ECC circuit 107 at times t0 to t3, t5, t6, t8, t10 are the same as the operations of the ECC circuit 107 at times t0 to t3, t5, t6, t8, t10, the explanation thereof is omitted. In the following description, the operations of the ECC circuit 107 at times t4, t7, t9 are explained.

At time t4, if an error correction process for data A is completed in the stage operation unit 111-3 of the stage 3, an error bit number of data A is derived and the error bit number of data A and attribute information of data A are supplied to the error number history table 131. As a result, the error bit number corresponding to the attribute information of data A is updated and the error number history table 131 is shifted from state α to state β.

Further, at time t4, if the error number history table 131 is updated, the table control unit 132 supplies a new parameter to a stage in which data having updated attribute information is subjected to an operation process.

Therefore, when data C has the same attribute information as data A, the table control unit 132 supplies new parameter P_{1β(C)} to the stage 1 that performs the operation process of data C. At this time, the stage operation unit 111-1 of the stage 1 changes the operation from the operation based on parameter P_{1α(C)} to the operation based on parameter P_{1β(C)}.

Further, when data B has the same attribute information as data A, the table control unit 132 supplies new parameter P_{2β(B)} to the stage 2 that performs the operation process of data B. At this time, the stage operation unit 111-2 of the stage 2 changes the operation from the operation based on parameter P_{2α(B)} to the operation based on parameter P_{2β(B)}.

At time t7, if the error correction process for data B is completed in the stage operation unit 111-3 of the stage 3, an error bit number of data B is derived and the error bit number of data B and attribute information of data B are supplied to the error number history table 131. As a result, the error bit number corresponding to the attribute information of data B is updated and the error number history table 131 is shifted from state β to state γ.

Further, at time t7, if the error number history table 131 is updated, the table control unit 132 supplies a new parameter to the stage that performs the operation process of data having updated attribute information.

The table control unit 132 supplies new parameter P_{2γ(C)} to the stage 2 that performs the operation process of data C having the same attribute information as data A. At this time, the stage operation unit 111-2 of the stage 2 changes the operation from the operation based on parameter P_{2β(C)} to the operation based on parameter P_{2γ(C)}.

At time t9, if the error correction process with respect to data C is completed in the stage operation unit 111-3 of the stage 3, an error bit number of data C is derived and the error bit number of data C and attribute information of data C are supplied to the error number history table 131. As a result, the error bit number corresponding to the attribute information of data C is updated and the error number history table 131 is shifted from state γ to state Δ.

Further, at time t9, if the error number history table 131 is updated, the table control unit 132 supplies a new parameter to the stage that performs the operation process of data having updated attribute information.

The table control unit 132 supplies new parameter P_{2Δ(D)} to the stage 2 that performs the operation process of data D having the same attribute information as data A. At this time, the stage operation unit 111-2 of the stage 2 changes the operation from the operation based on parameter P_{2γ(D)} to the operation based on parameter P_{2Δ(D)}.

Thus, in the operation example 1, a new parameter is not supplied to the stage operation unit 111 that already performs the operation when the error number history table is updated. However, as shown in the operation example 2, it is possible to change the operating condition by use of the new parameter and perform the operation even if the operation unit 111 is performing the operation.

<Operation and Effect of Memory System According to First Embodiment>

According to the first embodiment described above, the ECC circuit 107 feeds back an error correction result to the table and determines an optimum operating condition of the operation unit that performs the error correction based on the past error correction result before making an error correction.

The ECC circuit 107 performs the operation process in a pipeline form to enhance the error correction processing ability and control the operation speed of each stage according to the parameter. However, as shown in this embodiment, if the ECC circuit does not include the stage management unit 120 and operation parameter control unit 130, an error bit number related to input data cannot be predicted and it becomes difficult to perform the operation with a parameter set to an optimum value in a desired operation mode. Further, since the error bit number dynamically varies according to the use state of the flash memory 109, it is difficult to specify an optimum parameter without feedback.

However, by use of the ECC circuit of this embodiment, various attribute information and information of error bit numbers related to the attribute information are set in a table form and the error correction process can be performed in an optimum condition by use of the past error correction result when the error correction is made.

Thus, the operation parameter of each stage in the pipeline of the error correcting circuit can be dynamically optimized with respect to a desired operation mode. As a result, the throughput performance of data transfer and low-power consumption performance can be enhanced.

The ECC circuit 107 according to this embodiment can be used in both cases of writing data in the flash memory 109 and reading data from the flash memory 109 and is more effective in the error correction process with respect to data read from the flash memory 109. As described above, the error bit number dynamically varies according to the type of data stored in the flash memory 109, the operation method of the flash memory 109 and the like. In this embodiment, a dynamic variation in the error bit number can be determined to instantly cope with the error correction processing operation. Therefore, the ECC circuit of this embodiment is more effectively used in the error correction process with respect to read data from the flash memory 109.

### Second Embodiment

Next, a memory system 100 according a second embodiment is explained. In the first embodiment, a case wherein the error correction process is performed in the optimum condition based on attribute information of data to be error-corrected is explained, but in the second embodiment, a case wherein the error correction process is performed in an optimum condition based on a cycle number required for the error correction process in a stage operation unit 111 is explained. The basic configuration of a semiconductor memory device of the second embodiment is the same as that explained in the first embodiment, and therefore, the detailed explanation thereof is omitted. Further, the term “cycle” used in this case indicates a clock number or time required for performing an operation of the error correction process of data.

<Configuration of ECC Circuit According to Second Embodiment>

As shown in FIG. 10, an ECC circuit 107 includes an operation unit 110, cycle counter 150, operation parameter control unit 130 and operation control unit 140.

Further, as shown in FIG. 11, the cycle counter 150 includes a stage cycle counter 151-1 of a stage 1 to a stage cycle counter 151-N of a stage N corresponding in number to the stages of a stage operation unit 111. If the stage cycle counter 151-1 of the stage 1 to the stage cycle counter 151-N of the stage N are not distinguished, they are simply referred to as stage cycle counters 151.

The stage cycle counter 151 counts the number of cycles of the operation process performed by the stage operation unit 111 of the same stage. When the stage operation unit 111 of the same stage finishes the operation, the stage cycle counter 151 supplies the number of cycles required for the stage operation unit 111 to perform the operation of input data to a table control unit 132.

Further, an operation parameter control unit 130 includes a status of cycle number table 134, table control unit 132, target cycle number table 135 and the like.

As shown in FIG. 12, the status of cycle number table 134 is a table that stores cycle numbers respectively required for the operation processes for the stage numbers 1 to N. For example, the cycle number related to the stage number of the status of cycle number table 134 is updated each time the operation unit 110 performs error correction for input data.

As the cycle number stored in the status of cycle number table 134, an average of several accesses in the past for the corresponding stage, a value of one cycle at the preceding access time or the like may be considered. When an average of several accesses in the past is taken, a storage area such as a buffer that separately holds to-be-averaged values is provided in the memory system 100 and an average value is stored in the status of cycle number table 134.

Further, when a cycle number is not set for a preset stage number, a desired number is set as the cycle number.

As shown in FIG. 13, the target cycle number table 135 is a table that stores standard cycle numbers (that are also referred to as target cycle numbers) set for the respective stages. The table is used to select a target cycle number when a stage number is input. The table may be previously set or freely set by the user.

As is explained in the first embodiment, the user can select a “throughput preference mode” or “power-consumption preference mode”.

As a method for selecting an optimum parameter according to the mode, (i) a method for selecting an optimum table corresponding to a selected mode from plural tables previously set in the target cycle number table 135, (ii) a method for reading an optimum table corresponding to a selected mode from a RAM 105 and overwriting the table in the target cycle number table 135, (iii) a method for subjecting a table previously set in the target cycle number table 135 to an operation according to a selected mode and the like are provided.

The table control unit 132 inputs a stage number to be updated to the target cycle number table 135 and acquires a target cycle number of the stage. Then, the control unit inputs the stage number to be updated to the status of cycle number table 134 and acquires a status of cycle number corresponding to the stage. Further, the table control unit 132 compares the values of the target cycle and the status cycle to derive a parameter of a stage to be updated.

When the table control unit 132 derives a parameter, for example, a parameter set having plural parameters stored therein is prepared in a preset storage area (not shown) of the ECC circuit 107, RAM 105 or the like.

Then, if the difference between the target cycle number and the status of cycle number is less than a preset number, the table control unit 132 selects a reference parameter set as a reference value.

Further, if the target cycle number is larger than the status of cycle number by a preset number or more, it is necessary to reduce the processing time of the stage operation unit 111 of the updated stage. In this case, the table control unit 132 derives a parameter used for increasing the processing speed of the stage operation unit 111 by one step from the reference speed, for example. If the status of cycle number is larger than the target cycle number by a preset number or more and the difference therebetween is large, a parameter used for further increasing the processing speed according to the difference may be derived.

On the other hand, if the status of cycle number is less than the target cycle number by a preset number or more, the processing time of the stage operation unit 111 of the stage to be updated can be made long. In such a case, the table control unit 132 derives a parameter used for decreasing the processing speed of the stage operation unit 111 by one step from the reference speed, for example. If the status of cycle number is less than the target cycle number by a preset number or more and the difference therebetween is large, a parameter used for further decreasing the processing speed according to the difference may be derived.

<Operation of ECC Circuit According to Second Embodiment>

A case wherein the error correction process of data is performed by use of the ECC circuit 107 according to this embodiment is explained.

Data (input data) to be error-corrected is input to the stage operation unit 111-1 of the stage 1. Then, the table control unit 132 acquires a status of cycle number in the stage 1 from the status of cycle number table 134. Further, the table control unit 132 acquires a target cycle number in the stage 1 from the target cycle number table 135. Next, the table control unit 132 compares the values of the target cycle and status cycle to derive a parameter for the stage 1.

After this, the table control unit 132 supplies the derived parameter to the stage operation control unit 141-1 of the stage 1. The stage operation control unit 141-1 of the stage 1 supplies a control signal based on the acquired parameter to the stage operation unit 111-1 of the stage 1. When receiving the control signal, the stage operation unit 111-1 of the stage 1 starts an error correction process for input data based on the control signal.

When terminating the operation, the stage operation unit 111-1 of the stage 1 supplies input data subjected to the operation process to the stage operation unit 111-2 of the stage 2 that is next to the stage 1. At this time, the stage cycle counter 151-1 of the stage 1 supplies a cycle number (status of cycle number) required for the operation by the stage operation unit 111-1 of the stage 1 to the status of cycle number table 134.

The table control unit 132 acquires a status of cycle number in the stage 2 from the status of cycle number table 134. Further, the table control unit 132 acquires a target cycle number in the stage 2 from the target cycle number table 135. Next, the table control unit 132 compares the values of the target cycle and status cycle to derive a parameter for the stage 2.

After this, the table control unit 132 supplies the derived parameter to the stage operation control unit 141-2 of the stage 2. The stage operation control unit 141-2 of the stage 2 supplies a control signal based on the acquired parameter to the stage operation unit 111-2 of the stage 2. When receiving the control signal, the stage operation unit 111-2 of the stage 2 starts an error correction process for input data based on the control signal. The same process is repeatedly performed until the error correction process of input data is completed.

<Operation and Effect of Memory System According to Second Embodiment>

According to the second embodiment, the ECC circuit 107 feeds back the cycle number required for the error correction process and determines an optimum operating condition of the operation unit that performs an error correction according to the cycle number of the operation performed in the past before the error correction.

By use of the ECC circuit of this embodiment, an error correction process can be performed in the optimum condition. Therefore, like the first embodiment, an operation parameter of each stage in the pipeline of the error correcting circuit can be dynamically optimized with respect to a desired operation mode. As a result, the throughput performance of data transfer and low-power consumption performance can be enhanced.

### Third Embodiment

Next, a memory system 100 according a third embodiment is explained. The basic configuration of a semiconductor memory device of the third embodiment is the same as that explained in the second embodiment, and therefore, the detailed explanation thereof is omitted.

<Configuration of ECC Circuit According to Third Embodiment>

As shown in FIG. 14, an operation parameter control unit 130 includes a status of cycle number table 134, table control unit 132, parameter table 136 and the like.

As shown in FIG. 15, the parameter table 136 is a table that stores optimum parameters of the respective stages with respect to the cycle numbers. The table is a table of parameter values for the respective cycle numbers and permits a parameter value to be selected when a cycle number is input. The table may be previously set or freely set by the user.

P_{xy} shown in FIG. 15 is a parameter of each stage, X indicates a stage number and Y indicates a cycle number. That is, P_{xy} is a parameter when the stage is X and the error bit number is Y. C indicates the maximum value of the cycle number.

As is explained in the first and second embodiments, the user can select a “throughput preference mode” or “power-consumption preference mode”.

As a method for selecting an optimum parameter according to the mode, (i) a method for selecting an optimum table corresponding to a selected mode from plural tables previously set in the parameter table 136, (ii) a method for reading an optimum table corresponding to a selected mode from a RAM 105 and overwriting the table in the parameter table 136, (iii) a method for subjecting a table previously set in the parameter table 136 to an operation according to a selected mode and the like are provided.

The table control unit 132 inputs a stage number to be updated to the status of cycle number table 134 and acquires a status of cycle number of a corresponding stage. Then, the table control unit 132 derives a parameter of the stage to be updated by inputting the status of cycle number to the parameter table 136.

<Operation and Effect of Memory System According to Third Embodiment>

According to the third embodiment, the ECC circuit 107 feeds back the cycle number required for the error correction process and determines an optimum operating condition of the operation unit that makes an error correction according to the cycle number of the operation performed before the error correction.

By use of the ECC circuit of this embodiment, like the second embodiment, an operation parameter of each stage in the pipeline of the error correcting circuit can be dynamically optimized with respect to a desired operation mode. As a result, the throughput performance of data transfer and low-power consumption performance can be enhanced.

### Fourth Embodiment

Next, a memory system 100 according a fourth embodiment is explained. The basic configuration of a semiconductor memory device of the fourth embodiment is the same as that explained in the first embodiment, and therefore, the detailed explanation thereof is omitted.

<Configuration of ECC Circuit According to Fourth Embodiment>

As shown in FIG. 16, an operation parameter control unit 130 includes a table control unit 132 and parameter table 137.

As shown in FIG. 17, the parameter table 137 is a table that stores optimum parameters of the respective stages with respect to attribute information. The table is a table of parameter values for the respective attribute information numbers of input data to be error-corrected and permits a parameter value to be selected when attribute information is input. The table may be previously set or freely set by the user.

P_{xy} shown in FIG. 17 is a parameter of each stage, X indicates a stage number and Y indicates attribute information. That is, P_{xy} is a parameter when the stage is X and attribute information is Y. Parameters corresponding to attribute information Attr1 to AttrQ are prepared in the parameter table 137.

As explained before, the user can select a “throughput preference mode” or “power-consumption preference mode”. As a method for selecting an optimum parameter, (i) a method for selecting an optimum table corresponding to a selected mode from plural tables previously set in the parameter table 137, (ii) a method for reading an optimum table corresponding to a selected mode from a RAM 105 and overwriting the table in the parameter table 137, (iii) a method for subjecting a table previously set in the parameter table 137 to an operation according to a selected mode and the like are provided.

As the tables of the parameter table 137, the memory system 100 may include tables for the respective types of attribute information or the user may form the tables.

When receiving input data or attribute information supplied from each stage management unit 121, the table control unit 132 selects a parameter from the parameter table 137. Then, the table control unit 132 supplies the thus acquired parameter to the corresponding stage operation control unit 141. As a result, the error correction process for input data can be performed in an optimum condition.

<Operation and Effect of Memory System According to Fourth Embodiment>

According to the fourth embodiment, the ECC circuit 107 determines an optimum operating condition of the operation unit that performs an error correction process based on attribute information of data before the error correction process.

By use of the ECC circuit of this embodiment, an error correction process can be performed in the optimum condition. Therefore, like the first embodiment, an operation parameter of each stage in the pipeline of the error correcting circuit can be dynamically optimized with respect to a desired operation mode. As a result, the throughput performance of data transfer and low-power consumption performance can be enhanced.

(Modification or the Like)

In the first and fourth embodiments using attribute information, the parameter is determined based on one type of attribute information, a parameter may be determined based on plural types of attribute information. For example, an error bit number can be derived based on plural types of attribute information and a parameter may be determined based on the error bit number.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller comprising:
a plurality of operation units provided for respective stages to perform an error correction process for one of data supplied from an external device and data read from a nonvolatile semiconductor memory,
a management unit provided for the respective plural operation units which manages preset information related to the data input to the corresponding operation unit, and
a parameter control unit which outputs a parameter used for controlling an operation of the operation unit based on the preset information when receiving the preset information from the management unit.

2. The memory controller of claim 1, wherein the plural stages have respective stage numbers and the parameter control unit includes a first table which holds a relationship between the error bit numbers of the data derived by the operation unit and preset information of the data, a second table which holds the parameters corresponding to the error bit numbers and stage numbers, and a table control unit which acquires an error bit number from the first table based on the preset information received from the management unit and selects a parameter from the second table based on the acquired error bit number and a stage number related to the operation unit that performs an operation for data having the preset information.

3. The memory controller of claim 2, wherein the parameter control unit changes the parameter in the second table according to a preset condition.

4. The memory controller of claim 1, wherein the plural stages have respective stage numbers and the parameter control unit includes a first table which holds the parameters corresponding to the preset information of the data and stage numbers, and a table control unit which selects a parameter from the first table based on the preset information received from the management unit and the stage number related to the operation unit that performs an operation for data having the preset information.

5. The memory controller of claim 4, wherein the parameter control unit changes the parameter in the first table according to a preset condition.

6. The memory controller of claim 1, wherein the parameter control unit supplies a parameter to the operation unit during the operation.

7. The memory controller of claim 1, further comprising a plurality of operation control units respectively provided for the plural operation units and each which supplies a control signal to the corresponding operation unit based on the parameter received from the parameter control unit.

8. A memory controller comprising:
a plurality of operation units respectively provided for a plurality of stages to perform an error correction process for one of data supplied from an external device and data read from a nonvolatile semiconductor memory,
a counter provided for the plural operation units to count time required for the operation unit to perform the operation, and
a parameter control unit which outputs a parameter used for controlling the operation of the operation unit based on the time when receiving the time from the counter.

9. The memory controller of claim 8, wherein the plural stages have respective stage numbers and the parameter control unit includes a first table which holds a relationship between the stage numbers and times required for the operation units of stages corresponding to the stage numbers to perform operations, a second table which holds a relationship between the stage numbers and references times allocated to the operations of the operation units of the stages corresponding to the stage numbers, and a table control unit which acquires the time from the first table based on the stage number, acquires the reference time from the second table and derives a parameter based on a magnitude relationship between the time and the reference time.

10. The memory controller of claim 8, wherein the plural stages have respective stage numbers and the parameter control unit includes a first table which holds a relationship between the stage numbers and times required for the operation units of stages corresponding to the stage numbers to perform operations, a second table which holds the parameters corresponding to the times and stage numbers, and a table control unit which acquires the time from the first table based on the stage number and selects a parameter from the second table based on the acquired time and the stage number.

11. A memory system comprising:
a nonvolatile semiconductor memory that stores data supplied from an external device,
a plurality of operation units provided for respective stages and each which performs an error correction process for one of data supplied from the external device and data read from the nonvolatile semiconductor memory,
a management unit provided for the respective plural operation units to manage preset information related to the data input to the corresponding operation unit, and
a parameter control unit which outputs a parameter used for controlling an operation of the operation unit based on the preset information when receiving the preset information from the management unit.

12. The memory system of claim 11, wherein the plural stages have respective stage numbers and the parameter control unit includes a first table which holds a relationship between error bit numbers of the data derived by the operation units and preset information of the data, a second table which holds the parameters corresponding to the error bit numbers and the stage numbers, and a table control unit which acquires an error bit number from the first table based on the preset information received from the management unit and selects a parameter from the second table based on the acquired error bit number and the stage number related to the operation unit that performs an operation for data having the preset information.

13. The memory system of claim 12, wherein the parameter control unit changes the parameter in the second table according to a preset condition.

14. The memory system of claim 11, wherein the plural stages have respective stage numbers and the parameter control unit includes a first table which holds the parameters corresponding to preset information of the data and the stage numbers, and a table control unit which selects a parameter from the first table based on the preset information received from the management unit and the stage number related to the operation unit that performs an operation for data having the preset information.

15. The memory system of claim 14, wherein the parameter control unit changes the parameter in the first table according to a preset condition.

16. The memory system of claim 11, wherein the parameter control unit supplies a parameter to the operation unit during the operation.

17. The memory system of claim 11, further comprising a plurality of operation control units respectively provided for the plural operation units and each which supplies a control signal to the corresponding operation unit based on the parameter received from the parameter control unit.
